(19) United States
(12) Patent Application Publication
(10) Pub. No.: US 2016/0086698 A1
(43) Pub. Date: Mar. 24, 2016

(54) DIELECTRIC COATING

(71) Applicant: Ronald C. Parsons and Denise M. Parsons, trustees under the Ronald C. Parsons and Denise M. Parsons, Houston, TX (US)

(72) Inventor: Ronald C. Parsons, Houston, TX (US)

(73) Assignee: Ronald C. Parsons and Denise M. Parsons, trustees under the Ronald C. Parsons and Denise M. Parsons

(21) Appl. No.: 14/847,647

(22) Filed: Sep. 8, 2015

Related U.S. Application Data
(63) Continuation-in-part of application No. 14/495,302, filed on Sep. 24, 2014, now abandoned.

(51) Int. Cl. H01B 17/42; H01B 13/16; H01B 7/02; H01B 13/00; H01B 7/14

(52) U.S. Cl. CPC H01B 17/42; H01B 13/003; H01B 7/145; H01B 7/0208; H01B 13/16

(57) ABSTRACT

Herein disclosed is an insulated wire comprising an insulating dielectric sleeve made with ultraviolet (UV) light cured material, wherein the dielectric sleeve is able to withstand a temperature of 170° C. and above and there is no air space between the dielectric sleeve and the underlying substance. In an embodiment, the dielectric sleeve is a first coat, or an intermediate coat, or a last coat for the wire. In an embodiment, the dielectric sleeve has a dielectric range of no less than 1000 volts per mil. In an embodiment, the dielectric sleeve increases the useable life of the wire. In an embodiment, the insulated wire further comprises one or more thermoplastic coatings. This method may be added to an existing insulated wire production process. A system for forming such UV cured insulating coating is also discussed.

### CROSS REFERENCE TO RELATED PATENTS

This application is a continuation-in-part application of U.S. patent application Ser. No. 14/495,302, filed Sep. 24, 2014, the disclosure of which is incorporated herein in its entirety for all purposes.

### STATEMENT REGARDING FEDERALLY SPONSORED RESEARCH OR DEVELOPMENT

Not applicable.

### BACKGROUND

The treeing effect of electricity in dielectric coatings is very costly to industry. Treeing is the degrading of the insulation on electrical wire. This is extremely costly when the wiring is in a damp or wet environment. Subsea cable consists of multiple gage wires in a large bundle. Offshore cables are very heavy and generally laid in place by ships equipped with large spools.

When the insulation fails, the electric wire is grounded by the water or dampness causing a short circuit. The wire will burn through and is no longer usable. The short circuit may damage the wires touching it. As the insulation degrades, the wire loses efficiency. To repair a cable in this situation, robots, divers and a lot of expensive equipment is needed.

In electrical engineering, treeing is an electrical pre-breakdown phenomenon in solid insulation. It is a damaging process due to partial discharges and progresses through the stressed dielectric insulation, in a path resembling the branches of a tree. Treeing of solid high-voltage cable insulation is a common breakdown mechanism and source of electrical faults in underground power cables.

Electrical treeing first occurs and propagates when a dry dielectric material is subjected to high and divergent electrical field stress over a long period of time. Electrical treeing is observed to originate at points where impurities, gas voids, mechanical defects, or conducting projections cause excessive electrical field stress within small regions of the dielectric. This can ionize gases within voids inside the bulk dielectric, creating small electrical discharges between the walls of the void. An impurity or defect may even result in the partial breakdown of the solid dielectric itself. Ultraviolet light and ozone from these partial discharges (PD) then react with the nearby dielectric, decomposing and further degrading its insulating capability. Gases are often liberated as the dielectric degrades, creating new voids and cracks. These defects further weaken the dielectric strength of the material, enhance the electrical stress, and accelerate the PD process.

In the presence of water, a diffuse, partially conductive 3D plume-like structure, called a water tree, may form within the polyethylene dielectric used in buried or water-immersed high voltage cables. The plume is known to consist of a dense network of extremely small water-filled tubules. Individual tubules are extremely difficult to see using optical magnification, so their study usually requires using a scanning electron microscope (SEM). Water trees begin as a microscopic region near a defect. They then grow under the continued presence of a high electrical field and water. Water trees may eventually grow to the point where they bridge the outer ground layer to the center high voltage conductor, leading to complete electrical failure at that point. Another type of tree-like structure can form with or without the presence of water. Called an electrical tree, it also forms within a polyethylene dielectric (as well as many other solid dielectrics). Electrical trees also originate where bulk or surface defects create excessive electrical stress that initiates dielectric breakdown in a small region. This permanently damages the insulating material in that region. Further tree growth then occurs through as additional small electrical breakdown events (called partial discharges). Electrical tree growth may be accelerated by rapid voltage changes, such as utility switching operations. Also, cables carrying high voltage DC may also develop trees over time as electrical charges migrate into the dielectric nearest the HV conductor. The region of injected charge (called a space charge) amplifies the electrical field in the remaining dielectric, stimulating further tree growth. Since the tree itself is typically partially conducting, its presence also increases the electrical stress in the region between the tree and the opposite conductor. Unlike water trees, the individual channels of electrical trees are larger and more easily seen. Some trees may initially start out as water trees, and then evolve into electrical trees. Treeing has been a long-term failure mechanism for buried polymer-insulated high voltage power cables, first reported in 1969. In a similar fashion, 2D trees can occur along the surface of a highly stressed dielectric, or across a dielectric surface that has been contaminated by dust or mineral salts. Over time, these partially conductive trails can grow until they cause complete failure of the dielectric. Electrical tracking, sometimes called dry banding, is a typical failure mechanism for electrical power insulators that are subjected to salt spray contamination along coastlines. The branching 2D and 3D patterns are sometimes called Lichtenberg figures.

2D carbonized electrical trees (or tracking) across the surface of a polycarbonate plate that was part of a trigatron. These partially conducting paths ultimately led to premature breakdown and operational failure of the device

Electrical treeing or “Lichtenberg figures” also occur in high-voltage equipment just before breakdown. Following these Lichtenberg figures in the insulation during postmortem investigation of the broken down insulation can be most useful in finding the cause of breakdown. An experienced high-voltage engineer can see from the direction and the type of trees and their branches where the primary cause of the breakdown was situated and possibly find the cause. Broken-down transformers, high-voltage cables, bushings, and other equipment can usefully be investigated in this way; the insulation is unrolled (in the case of paper insulation) or sliced in thin slices (in the case of solid insulation systems), the results are sketched and photographed and form a useful archive of the breakdown process.

Therefore, there is continuing need to develop system and method to improve the life of wire insulation. Such system and method should not be cost prohibitive for actual implementation.

### SUMMARY

Herein disclosed is an insulated wire comprising an insulating dielectric sleeve made with ultraviolet (UV) light cured material, wherein the dielectric sleeve is able to withstand a temperature of 170° C. and above and there is no air space between the dielectric sleeve and the underlying substance. In an embodiment, the dielectric sleeve is a first coat, or an intermediate coat, or a last coat for the wire. In an embodiment, the dielectric sleeve has a dielectric range of no less than 1000 volts per mil. In an embodiment, the dielectric sleeve increases the useable life of the wire. In an embodiment, the insulated wire further comprises one or more thermoplastic coatings.

In an embodiment, the dielectric sleeve is able to withstand a temperature of 190° C. and above. In an embodiment, the dielectric sleeve is able to withstand a temperature of 300° C. and above. In an embodiment, the dielectric sleeve is able to stop burn-out of the wire contained within.

Herein also disclosed is a method of making an insulated wire comprising: applying a coating material to the wire under vacuum; and curing the wire under UV light to form an insulating dielectric sleeve; wherein the dielectric sleeve is able to withstand a temperature of 170° C. and above and there is no air space between the dielectric sleeve and the underlying substance.

In an embodiment, the dielectric sleeve is a first coat, or an intermediate coat, or a last coat for the wire. In an embodiment, the dielectric sleeve has a dielectric range of no less than 1000 volts per mil. In an embodiment, the method comprises coating the wire with one or more layers of thermoplastic material.

In an embodiment, applying a coating material to the wire is accomplished by pulling the wire through a mist of coating material in a vacuum coater. In an embodiment, the coating material thickness is controlled by a vacuum clearing the vacuum coater. In an embodiment, applying a coating material to the wire is accomplished by pulling the wire through a tank of coating material. In an embodiment, the coating material thickness is determined by a sizing ring.

In an embodiment, the disclosed method is combined with an existing process of insulated wire production. In an embodiment, the existing process of insulated wire production applies thermoplastic coatings. In an embodiment, the speed at which the insulating dielectric sleeve is formed matches the speed at which the thermoplastic coatings are applied.

Further disclosed herein is a system of making an insulated wire comprising an applicator to apply a coating material to the wire; and a UV light chamber to cure the coating material and form an insulating dielectric sleeve.

In some embodiments, the applicator comprises a vacuum coater or a tank containing the coating material. In some embodiments, the dielectric sleeve has a dielectric range of no less than 1000 volts per mil. In some embodiments, the UV coating system is combined with an existing system of insulated wire production.

These and other embodiments, features and advantages will be apparent in the following detailed description and drawings.

### BRIEF DESCRIPTION OF THE DRAWINGS

FIG. 1 illustrates a method of applying ultraviolet (UV) light cured dielectric coating to a wire, according to an embodiment of this disclosure.

### DETAILED DESCRIPTION

OVERVIEW. In order to improve the life of electrical wire, an insulating dielectric sleeve made with UV cured material is added to a wire. The UV cured material has a high dielectric factor. This factor is several times higher than the present insulation being used and will increase the useable life. The UV cured material is able to stand high temperature operation conditions. The dielectric range for the insulating dielectric sleeve made with UV cured material is no less than 1000 volts per mil. In various embodiments, the dielectric coating is able to withstand temperatures of 170° C. and above. In various embodiments, the dielectric coating is able to withstand temperatures of 190° C. and above. In various embodiments, the dielectric coating is able to withstand temperatures of 300° C. and above. In various embodiments, the dielectric coating is able to withstand temperatures of 350° C. and above. In various embodiments, the dielectric coating is able to withstand temperatures of 400° C. and above. This is very important because a cable contains many coated wires and the ability to withstand high temperatures can prevent damage to other wires or to stop burn-out if one of the wires is shorted out in use. Existing wire coatings do not have this temperature tolerance and thus cannot prevent such damage.

The process of coating the UV cured material onto a wire is at a speed that matches the speed of thermoplastic insulation application presently used. As such, it is easy to incorporate such a process into an existing insulated wire production process.

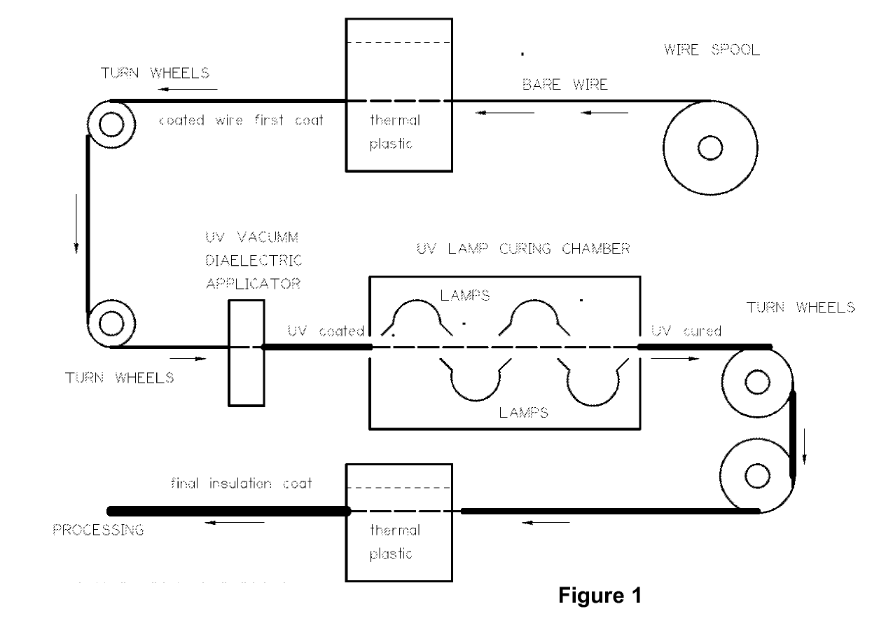

Referring to FIG. 1, a wire is pulled through a thermoplastic material and sizing ring. Very often, the first coat is thin and fills in the voids caused by multiple twisted wires. The first coat is designed to have a low adhesive factor so that the wire may be easily stripped for connections. As such, the wire is pulled through thermoplastic insulation material and sized.

In the embodiment as shown in FIG. 1, the UV light cured dialectic coating is applied between the first and second coats of thermoplastic insulation. After the first thin coat of insulation is applied, the wire is passed through a UV vacuum coater. The vacuum machine applies the material by pulling the wire through a mist of coating. The material thickness is determined by a vacuum clearing the coating chamber. The advantage of using a vacuum coater is that it reduces or eliminates any air space between the wire and the UV coating or the underlying coating and the UV coating. In the case of a burn out (caused by, e.g., a shorted wire), the reduced/eliminated air space will reduce the damage caused by the burn out.

Alternatively, the coating is be applied by pulling wire through a tank or vat of UV coating and then sized as how the thermoplastic insulation is sized. Such UV coating may be applied as a first coat, a last coat, or an intermediate coat/layer to enhance dielectric strength

The wire is then pulled through a UV curing chamber. This chamber as shown in FIG. 1 has 4 high intensity UV lights that cure the dielectric coating instantly. After holiday testing, the wire resumes the normal production process. Holiday testing is done electrically wherein the base metal is grounded and a current is put on the insulation.

This process or system may be added to the present production line for insulated wires or cables, for example, for making thermoplastic-sheathed cable (TPS).

Thermoplastic-sheathed cable (TPS) consists of an outer sheath of polyvinyl chloride (PVC) insulation (the thermoplastic element) covering a “core” of one or more conductors of annealed copper. Each of the current carrying conductors in the “core” is insulated by an individual thermoplastic sheath, colored to indicate the purpose of the conductor concerned. The Protective Earth conductor may also be covered with Green/Yellow (or Green only) insulation, although, in some countries, this conductor may be left as bare copper. With cables where the current carrying conductors are of a large Cross Sectional Area (CSA) and current carrying capacity, the Protective Earth conductor may be found to be of a smaller CSA, with a lower continuous current carrying capacity. The conductors used may be solid in cross-section or multi-stranded.

The following section discusses, as an example, how an insulated copper wire/cable is made. Other processes are also contemplated in this disclosure, as known to one skilled in the art. The process of forming a UV light cured dialectic coating may be incorporated into one of such processes.

The first step in the manufacturing process is wire draw, where copper rods are reduced to copper wires. After wire drawing, the wire is extremely brittle and can easily be fractured if flexed. Since finished copper wire must be flexible, the wire is softened, or annealed, at this point Annealing is accomplished by passing a large electrical current through the wire for a fraction of a second, raising its temperature briefly to 1000° F. To prevent oxidation of the wire, this step is performed in water. The water bath also cools and cleans the wire in preparation for the insulating step.

The wire, now soft and flexible, is passed through an extruder, where either a single or double coating of plastic is applied. High-density polyethylene pellets, colored one of ten industry-standard colors, are fed into the cool rear section of the extruder; as they are pushed forward, they are heated until they melt. Exiting the extruder, the coated wire, now traveling at approximately 60 miles per hour, passes through another cooling trough and is coiled on takeup reels.

Before the reels move to the next manufacturing operation, wire and insulation diameter are measured, and the wire is tested for such electrical properties as capacitance and resistance.

In the next step, the insulated wires are twisted into wire pairs—the ten standard insulation colors combined into 25 different industry-standard pair combinations. Twist lengths vary from two to seven inches, with the unit of change being 1/10-inch.

Each different pair combination of insulation colors has a unique twist length, so that when different twisted pairs are combined in the same cable, no two side-by-side pairs will have the same twist length, a situation that can lead to crosstalk and interference.

Then the wire is cabled and jacketed. At cabling, the units coming from the stranding operation are grouped together to form a multi-unit cable core. The process is similar to stranding—the units are passed through a faceplate that properly positions them in the cable core. The units are also twisted together on a rotating core truck to help control electrical interference and provide flexibility.

For air-core cables, the core wrap is applied at the cabling station. (Pressurizing the cable helps it resist the intrusion of moisture. A more dependable technique for preventing moisture from getting into a cable is to fill it with a gel-like filling compound. If the cable is to be gel-filled, the core wrap is applied after the filling compound is forced into the cable core. Depending on the technique preferred, the filling compound can be applied at the cabling station or during the next operation—jacketing.)

As mentioned, smaller, single-unit cable cores may come to the jacketing operation directly from stranding; larger, multi-unit cable cores go through the cabling operation before being sent to jacketing. At jacketing, several operations—gel-filling, armoring, jacketing, and printing—are performed to produce the finished cable.

The first step is for the filling compound to be added (for gel-filled cables). The cable core is heated to ensure that the filling compound penetrates all open spaces in the core. The heated core passes through the filling chambers, where the filling compound is added. And finally, a plastic core wrap is applied.

Both air-core and gel-filled cables used in outside-plant applications are armored, the next phase of jacketing. Depending on the cable design, a protective metal sheathing of either aluminum or aluminum and steel combined may be added during this manufacturing step. The aluminum acts as a grounding path for high-voltage surges that may be caused by lightning strikes and other eventualities in aerial cables, while steel adds mechanical protection for buried cable against pests such as rats and gophers. In most outside-plant cable designs, the metal sheathing is corrugated for added flexibility and coated with a flooding compound that protects the metals from corrosion and moisture damage.

The outer cable jacket is extruded in the next step. It is usually made from low-density polyethylene, black in color and resistant to ultraviolet light in case it is exposed to sunlight. This rugged plastic is the final protection for the enclosed cable against the environmental conditions underground or when strung to utility poles.

The jacketed cable then passes through a temperature—controlled water trough, which cools the jacket. The cable is dried, and the top layer of the jacket is heated slightly so that printer markings can be imprinted on it. Because of the heating, the markings are stamped into the jacket itself and will last the life of the cable.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The inclusion or discussion of a reference is not an admission that it is prior art to the present invention, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. An insulated wire comprising an insulating dielectric sleeve made with ultraviolet (UV) light cured material, wherein said dielectric sleeve is able to withstand a temperature of 170° C. and above and there is no air space between said dielectric sleeve and the underlying substance.

2. The insulated wire of claim 1 wherein the dielectric sleeve is a first coat, or an intermediate coat, or a last coat for the wire.

3. The insulated wire of claim 1 wherein the dielectric sleeve has a dielectric range of no less than 1000 volts per mil.

4. The insulated wire of claim 1 wherein the dielectric sleeve increases the useable life of the wire.

5. The insulated wire of claim 1 further comprising one or more thermoplastic coatings.

6. The insulated wire of claim 1 wherein said dielectric sleeve is able to withstand a temperature of 190° C. and above.

7. The insulated wire of claim 1 wherein said dielectric sleeve is able to withstand a temperature of 300° C. and above.

8. The insulated wire of claim 1 wherein said dielectric sleeve is able to stop burn-out of the wire contained within.

9. A method of making the insulated wire of claim 1.

10. A method of making an insulated wire comprising:
applying a coating material to the wire under vacuum; and
curing the wire under UV light to form an insulating dielectric sleeve;
wherein said dielectric sleeve is able to withstand a temperature of 170° C. and above and there is no air space between said dielectric sleeve and the underlying substance.

11. The method of claim 10 wherein the dielectric sleeve is a first coat, or an intermediate coat, or a last coat for the wire.

12. The method of claim 10 wherein the dielectric sleeve has a dielectric range of no less than 1000 volts per mil.

13. The method of claim 10 further comprising coating the wire with one or more layers of thermoplastic material.

14. The method of claim 10 wherein applying a coating material to the wire is accomplished by pulling the wire through a mist of coating material in a vacuum coater.

15. The method of claim 14 wherein the coating material thickness is controlled by a vacuum clearing the vacuum coater.

16. The method of claim 10 wherein applying a coating material to the wire is accomplished by pulling the wire through a tank of coating material.

17. The method of claim 16 wherein the coating material thickness is determined by a sizing ring.

18. The method of claim 10 combined with an existing process of insulated wire production.

19. The method of claim 18 wherein the existing process of insulated wire production applies thermoplastic coatings.

20. The method of claim 19 wherein the speed at which the insulating dielectric sleeve is formed matches the speed at which the thermoplastic coatings are applied.
